(19) United States
(12) Patent Application Publication
(10) Pub. No.: US 2025/0079741 A1
(43) Pub. Date: Mar. 6, 2025

(54) HIGH-SPEED CONNECTOR

(71) Applicant: Amphenol Corporation, Wallingford, CT (US)

(72) Inventors: Ba Pham, Vaughan (CA); Ali Hammoodi, Nashua, NH (US)

(73) Assignee: Amphenol Corporation, Wallingford, CT (US)

(21) Appl. No.: 18/810,673

(22) Filed: Aug. 21, 2024

Related U.S. Application Data
(60) Provisional application No. 63/580,489, filed on Sep. 5, 2023.

(51) Int. Cl. H01R 13/11; H01R 12/72; H01R 13/424; H01R 43/20

(52) U.S. Cl. CPC H01R 13/11; H01R 12/722; H01R 13/424; H01R 43/205

(57) ABSTRACT

A compact connector operable at data rates up to and beyond 200 Gbps includes a component that presses on high speed signal contact beams to deflect them into a preloaded state. The component may be attached to ground and/or low speed signal contact beams. Those contact beams may be preloaded by engaging their tips to features within the connector. When those contact beams are deflected into a preloaded state, the component presses against the high speed signal contact beams, deflecting them into a preloaded state. Tips on the high speed signal contact beams are not required for preloading and may be shortened relative to a conventional design to reduce stubs on high speed signal paths, which increases operating frequency of the connector. The component may include a conductive portion that connects ground contacts associated with the high speed signal terminals, which improves high frequency performance without additional components.

### CROSS-REFERENCE TO RELATED APPLICATIONS

This application claims priority to and the benefit of U.S. Provisional Patent Application No. 63/580,489, filed on Sep. 5, 2023, entitled “HIGH-SPEED CONNECTOR.” The contents of this application are incorporated herein by reference in their entirety

### BACKGROUND

This disclosure relates generally to an electrical connector and, more specifically, to a high-speed electrical connector with preloaded signal contacts with short beam tips.

Electrical connectors facilitate separable electrical connections. For example, components that are each electrically coupled to a connector may be coupled to each other via the connectors. In a data center, for example, servers and networking equipment may be arranged in racks. Each of these electronic devices may include connectors that mate with connectors terminating cables. When connectors terminating the cables are mated with the connectors of the electronic equipment, the cables connect the electronic devices. Inside each of the electronic devices, the connectors may be mounted to a printed circuit board (PCB) with other components that generate or process signals passed over the cables and through the mated connectors.

The connectors mounted within an electronic device may be configured as receptacle connectors. Each receptacle connector may have a port that includes signal contact beams interlaced with ground contact beams. The port may have an opening with rows of signal and ground contact beams on opposite sides. A mating connector, which may be configured as a plug connector, may have a component that fits within the opening of the port. The mating component of the plug connector may have rows of contact pads on opposite surfaces that align with the signal contact beams and the ground contact beams of the port. Such a mating component may be implemented as a printed circuit board, often called a paddle card.

Insertion of this mating component deflects the contact beams lining the opening of the port. As the beams are deflected, they generate a spring force against the contact pads on the mating component. The contact beams are shaped such that the amount of force generated at each contact pad is sufficient to form a reliable electrical connection between the beams and the pads.

In some connectors, the contact beams may be preloaded. Preloaded contact beams are shaped such that, in their rest states, they would extend into the opening of the port. The tips of these contact beams, however, are restrained from extending into the opening. Otherwise, a mating component inserted into the port could stub on the tips of the contact beams, which might prevent correct mating of the connector and the inserted component or might damage the connector. To restrain the tips of the contact beams, a connector housing may have a feature, sometimes called a preload shelf, adjacent to the opening of the port. The tips of the signal and ground contact beams may be hooked on this shelf such that they do not extend into the opening. Hooking the beams on the preload shelf requires the contact beams to be deflected from their rest state. As a result, the contact beams generate a force even before the mating component is inserted into the port. When the mating component is inserted, there is additional deflection of the beams, which increases the force generated by the contact beams. Preloading may increase the contact force for each beam relative to a connector without preloading or may enable the same amount of contact force with smaller components that move the contact beams a smaller amount.

### SUMMARY

According to an aspect of the present disclosure, a connector includes a port with an opening, the port including a plurality of contact beams disposed in a row, the plurality of contact beams including a plurality of first type contact beams and a plurality of second type contact beams. The connector also includes a component. The component is mechanically coupled to the first type contact beams and the second type contact beams, electrically coupled to the second type contact beams, and insulated from the second type contact beams.

Optionally, the connector also includes a housing including a plurality of channels aligned with respective contact beams of the plurality of contact beams.

Optionally, the contact beams of the plurality of contact beams each includes a proximal portion, a curved portion, a tip and a distal portion between the curved portion and the tip. The distal portions of the plurality of contact beams are disposed in respective channels of the plurality of channels, and the curved portions of the plurality of contact beams extend into the opening.

Optionally, the distal portions of the first type contact beams are engaged with the housing such that the first type contact beams are deflected to a preloaded position.

Optionally, the component urges the second type contact beams into a deflected state such that the second type contact beams are deflected into a preload position based on the first type contact beams being deflected into a preloaded position.

Optionally, the plurality of contact beams is a first plurality of contact beams. The row is a first row. The connector also includes a second plurality of contact beams disposed in a second row of signal contact beams and ground contact beams. The second plurality of contact beams includes a plurality of first type contact beams and a plurality of second type contact beams. The connector also includes a second component mechanically coupled to the first type contact beams and the second type contact beams of the second plurality of contact beams, electrically coupled to the second type contact beams of the second plurality of contact beams, and insulated from the second type contact beams of the second plurality of contact beams.

Optionally, the housing further comprises a second plurality of channels aligned with respective contact beams of the second plurality of contact beams.

Optionally, the contact beams of the second plurality of contact beams each comprises a proximal portion, a curved portion, a tip and a distal portion between the curved portion and the tip. The distal portions of the second plurality of contact beams are disposed in respective channels of the plurality of channels. The curved portions of the second plurality of contact beams extend into the opening, and the distal portions of the first type contact beams of the second plurality of contact beams are engaged with the housing such that the first type contact beams are deflected to a preloaded position.

Optionally, the second component urges the second type contact beams of the second plurality of contact beams into a deflected state such that the second type contact beams are deflected into a preload position based on the first type contact beams of the second plurality of contact beams being deflected into a preloaded position.

Optionally, the first plurality of contact beams and the second plurality of contact beams comprise mating portions of a plurality of contacts. The plurality of contacts also include mounting portions disposed in a plurality of rows at a mounting face of the connector. The mounting face couples the connector to a printed circuit board (PCB).

According to another aspect of the present disclosure, a connector includes a housing with an opening. The connector also includes a contact assembly disposed within the housing including an insulative portion and a plurality of contacts disposed in a row. Each contact of the plurality of contacts includes a beam with a proximal portion mechanically coupled to the insulative portion and a cantilevered portion. The cantilevered portion includes a contact portion extending into the opening, and a distal portion extending beyond the contact portion. The plurality of contacts comprises first type contacts and second type contacts, and the first type contacts have longer distal portions than the second type contacts. The contact assembly also includes a component with an insulative portion. The component is attached to the first type contacts and the insulative portion of the component abuts the second type contacts.

Optionally, the component further includes a conductive portion attached to the first type contacts.

Optionally, the conductive portion and the insulative portion of the component are attached.

Optionally, the insulative portion is plastic overmolded on the conductive portion such that the conductive portion and the plastic are attached.

Optionally, the first type contacts are ground contacts.

Optionally, the second type contacts are signal contacts.

Optionally, the second type contacts are disposed within the row in pairs, with each pair bounded on two sides by a ground contact.

Optionally, the opening has a first side and a second side opposite the first side. The contact assembly is a first contact assembly. The component is a first component. The plurality of contacts are a first plurality of contacts. The row is a first row and the first plurality of contacts in the first row are arranged at the first side of the opening with the first plurality of contacts between the first component and the first side of the housing. The connector also includes a second plurality of contacts, including the first type contacts and the second type contacts, disposed in a second row, parallel to the first row, arranged at a second side of the opening, and a second component including an insulative portion. The second component is attached to the first type contacts of the second plurality of contacts; and the insulative portion of the second component abuts the second type contacts of the second plurality of contacts.

Optionally, the housing includes a first preload shelf at the first side of the opening; and a second preload shelf at the second row at the second side of the opening.

Optionally, the distal portions of the first type contacts of the plurality of contacts of the first row engage the first preload shelf in a deflected state such that the first type contacts in the first row are in a preloaded condition. The distal portions of the first type contacts of the plurality of contacts of the second row engage the second preload shelf in a deflected state such that the first type contacts in the second row are in a preloaded condition.

Optionally, the second type contacts in the first row are deflected in a first direction away from a centerline of the opening based on mechanical coupling to the insulative portion of the first component and on mechanical coupling of the first component to the first type contacts in the first row. The second type contacts in the second row are deflected away from the centerline of the opening in a second direction, opposite the first direction, based on mechanical coupling to the insulative portion of the second component and on mechanical coupling of the second component to the first type contacts in the second row.

According to another aspect of the present disclosure, a method of assembling a connector including a housing with an opening including a mating port, and a row including a plurality of contact beams including first type contact beams and second type contact beams with each of the plurality of contact beams including a proximal portion, a distal portion, and a curved portion between the proximal portion and the distal portion, includes deflecting the plurality of contact beams from a rest state and positioning the plurality of beams within the housing such that the curved portions of the plurality of contact beams extend into the opening. The method also includes engaging the distal portions of the first type contact beams with the housing such that the first type contact beams are held in a preload state and the second type contact beams are held in a preload state by a component mechanically coupled to the first type contact beams and the second type contact beams.

Optionally, the first type contact beams have longer distal portions than the second type contact beams, and the distal portions of the second type contact beams are not engaged to the housing when the second type contact beams are held in the preload state.

Optionally, engaging the distal portions of the first type contact beams with the housing includes engaging tips of the first type contact beams to a preload shelf.

Optionally, the housing comprises a plurality of channels. Tips of the first type contact beams are engaged to the housing within channels of the plurality of channels when in the preload state. Tips of the second type contact beams are cantilevered within channels of the plurality of channels when in the preload state.

The foregoing features may be used, separately or together in any combination in any of the foregoing embodiments.

### BRIEF DESCRIPTION OF DRAWINGS

The accompanying drawings are not necessarily drawn to scale. For the purposes of clarity, not every component may be labeled in every drawing. In the drawings:

FIG. 1 is a perspective view of an exemplary connector that may incorporate preload features as described herein;

FIG. 2 is a perspective view of the connector of FIG. 1 with the connector housing cutaway to reveal an upper and a lower contact assembly;

FIG. 3 is a perspective view of the lower contact assembly of FIG. 2 with an insulative portion omitted;

FIG. 4 is a partially exploded view of the lower contact assembly of FIG. 3;

FIG. 5A is a perspective top view of a preload component for the lower contact assembly of FIG. 3;

FIG. 5B is a perspective bottom view of the preload component for the lower contact assembly of FIG. 3;

FIG. 6 is a perspective view of the connector of FIG. 1 and an enlarged cross-sectional view of a portion of the interface port taken along the line 6-6;

FIG. 7 is an enlarged cross-sectional view of a portion of the interface port taken along the line 7-7 in FIG. 6, revealing a distal portion of a first type contact engaged with a preload shelf of the housing; and

FIG. 8 is an enlarged cross-sectional view of a portion of the connector of FIG. 6, sectioned through the insulative housing at the distal portions of first type contacts in a plane parallel to the sectional plane of FIG. 6.

### DETAILED DESCRIPTION

The inventors have recognized and addressed the need for both high-frequency operation and sufficient mating force to form reliable connections in a compact connector. Within the connector, contacts may include beams that may be preloaded to provide a desired mating force without requiring all of the beams to have tips that engage other structures, such as a preload shelf, for preloading. In some examples, contacts within the connector may be arranged in one or more rows. Within each row, a first type contact may have longer distal portions than a second type of contact. One or more components may be attached to multiple of the first type contacts. That component may have an insulative portion that abuts the second type contacts.

The component may deflect one or more of the second type contacts for preloading. In some examples, the first type contacts may be preloaded by engaging their tips to a structure, such as a preload shelf of a connector housing, that holds them in a deflected state. In some examples, the second type contacts may be high speed signal contacts. Optionally, the first type contacts may be ground contacts and/or low speed signal contacts that are less susceptible to a loss of signal integrity than high speed signal contacts.

Use of such a component for preloading high speed signal contacts enables the distal portion of the contact beam to be short. The portion of the contact beam between the contact portion, designed to make contact to a pad of a mating component, and the tip of the beam may impact the integrity of signals on those contacts. That portion may form an electrical stub. Degradation of signal integrity in a connector as a result of a stub may increase with stub length and frequency. Shortening the stub length, such as results from eliminating the portion at the tip that might otherwise engage a preload shelf, enables higher frequency operation of the connector. With a component as described herein, a desired contact force may nonetheless be achieved through preloading.

In some examples, ground contact beams are retained in a deflected state for preloading by their tips engaging the connector housing. To preload the signal contact beams, a component may mechanically couple the signal contact beams to the ground contact beams. The component may be attached to the ground contact beams by welding, for example, and mechanically coupled to the signal contact beams. Thus, when the ground contact beams are preloaded through retention of their tips within the housing, the mechanical coupling of the component to the signal contact beams deflects the signal contact beams and results in preloading of the signal contact beams, as well.

Optionally, the component may have a conductive portion and an insulative portion. The conductive portion may be electrically and/or mechanically connected to the first type contacts and may serve as a support for the insulative portion. The conductive portion, for example, may be stamped from a sheet of metal and welded to the first type contacts. The insulative portion may be attached to the conductive portion, such may result from over molding plastic on the conductive portion.

In some examples, the conductive portion of the component may electrically connect ground contacts that separate high speed signal contacts. Such a configuration may increase signal integrity instead of or in addition to improvements resulting from shorter distal portions of high speed signal contacts. As the same component may enhance signal integrity in multiple ways, a significant improvement in signal integrity may be provided in a small volume, supporting miniaturization of the connector.

Techniques as described herein may be used in a connector with contact beams, such as a receptacle connector. Such a connector, for example, may have contact beams positioned according to the OSFP standard. The beams may be shaped to provide an insertion force of 40N or less, such as between 30-40 N, and an extraction force of 30N or less, such as between 20-30 N. The connector may be configured to support data rates of up to 200 Gbps per channel, using PAM4 modulation.

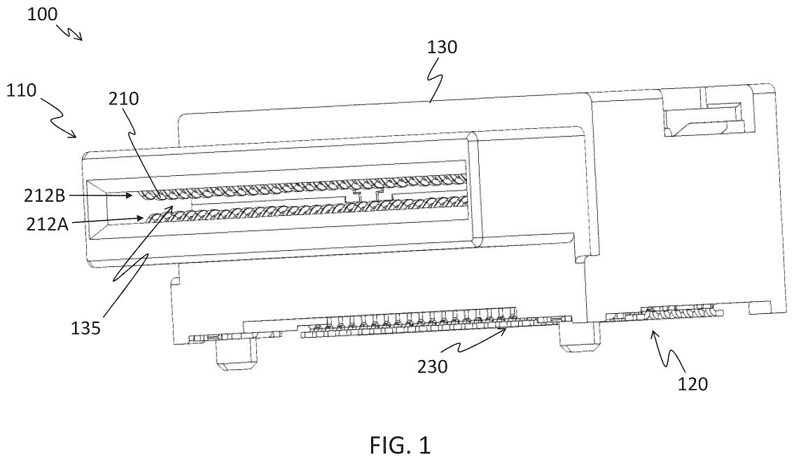

An example of such a connector in which one or more of the techniques described herein may be applied is shown in FIG. 1. FIG. 1 is a perspective view of a connector 100 that shows a port 110 configured to receive a mating component of a plug connector (not shown). In examples in which the connector is designed to meet the OSFP standard, the mating component may be a paddle card of a transceiver. The paddle card may be removably inserted into the opening 135 of port 110, here configured as a slot, to form electrical connections to the contacts 210. As shown, the contacts 210 are arranged in two rows 212A, 212B on opposite sides of opening 135. In the exemplary connector 100 in FIG. 1, the row 212A of contacts 210 may be referred to as the top row and row 212B of contacts 210 may be referred to as the bottom row, as row 212A is further from mounting face 120 than row 212B.

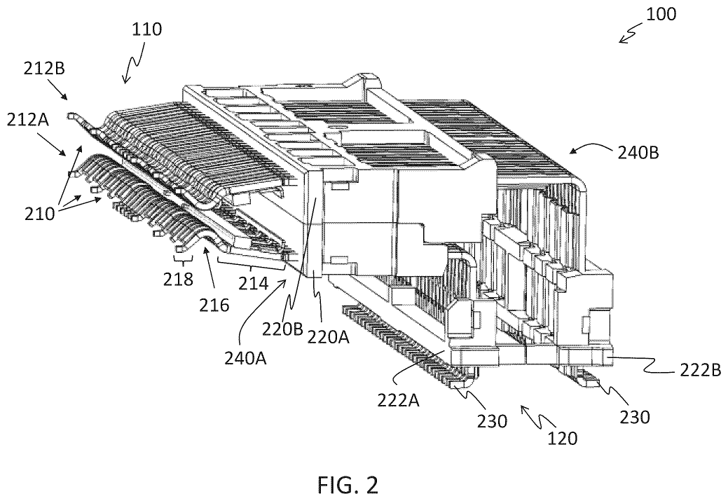

FIG. 2 is a perspective view of the connector 100 of FIG. 1 with the housing 130 removed to show contact assemblies 240A and 240B, each with one row of contacts 210. The connector 100 includes a mounting face 120. The mounting face 120 may facilitate mounting the connector 100 on a substrate, such as a printed circuit board (not shown). Ends of the contacts 210 within the connector 100 are exposed at the mounting face 120. In this example, the exposed mounting portions 230 of the contacts 210 are shaped for surface mount soldering to a printed circuit board (PCB) to facilitate electrical connection via the connector 100 to components on the PCB, for example. As shown, the interface port 110 and mounting face 120 are at orthogonal faces of a housing 130 of the connector 100. Techniques as described herein may be applied to connectors with contact beams in other configurations. For simplicity of description, the mounting face 120 may be referred to as the bottom or lower surface of connector 100. However, a connector may be used in any orientation.

In the example illustrated, connector 100 includes, in addition to housing 130, one or more contact assemblies. Each contact assembly may hold one or more rows of contacts. The contact assemblies may be held within the housing 130 such that contact portions 216 are exposed in opening 135 and mounting portions 230 are exposed at the mounting face 120.

In the example shown in FIGS. 1 and 2, there are two contact assemblies 240A and 240B having the same general construction. Each has one row of contacts 210, rows 212A and 212B respectively, in this example. The contacts 210 are held in one or more insulative portions, such as insulative portions 220A and 222A for contact assembly 240A and insulative portions 220B and 222B for contact assembly 240B.

Each of the contacts 210 has a mating end that includes contact portion 216 and a mounting end that includes mounting portion 230 joined by an intermediate portion that is held within the insulative portions of a contact assembly.

In the example illustrated, each of the mating ends of each of the contacts is a beam with a base, here with a proximal portion 214 protruding from insulative portion 220A or 2220B. Each of the mating ends includes a proximal portion 214, a contact portion 216, and a distal portion 218. In the example illustrated, each of the contacts has similar proximal portions 214 and contact portions 216. In the example illustrated, the contact portion 216 of each contact 210 is curved, creating a convex surface that can press against a contact pad on a mating component. The contact portion 216 of each contact 210 may extend into the opening 135 where it can press against a pad on the mating component.

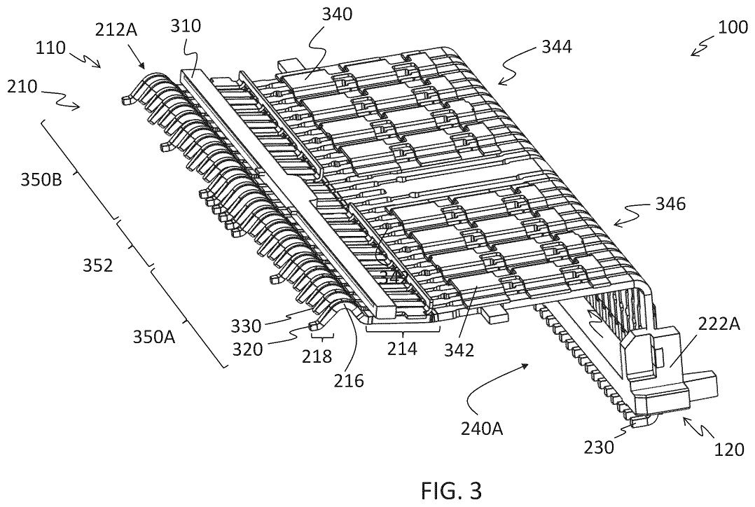

A distal portion 218 of each of the contacts extends beyond the contact portion 216. As can be seen in FIG. 2, some of the contacts 210 have longer distal portions than others, such that there are a first type of contact 320 and a second type contact 330 as indicated in FIG. 3, with the first type contact 320 having longer distal portions 218 than the second type contact 330.

Contact assemblies 240A and 240B differ in that contact assembly 240A is a lower contact assembly configured to fit in housing 130 with its contacts exposed along a lower surface of opening 135. In contrast, contact assembly 240B is an upper contact assembly configured to fit in housing 130 with its contacts exposed along an upper surface of opening 135. For both contact assembly 240A and 240B, the contacts include contact portions 216, here provided by a convex surface extending into opening 135. The contact portions 216 on the contacts 210 of the lower contact assembly 240A face upwards while the contact portions 216 on the upper contact assembly 240B face downward. As shown in FIG. 2, the contact portions 216 of the top row 212A of contacts 210 and the contact portions 216 of the bottom row 212B of contacts 210 are mirror images of each other. As such, an apex of each contact portion 216 in the top row 212A and an apex of each contact portion 216 in the bottom row 212B are the closest part of the two rows 212A, 212B to each other. Similarly, each of the contact assemblies 240A and 240B includes a component 310 to facilitate preloading. The component 310 biases contact tips into the surfaces that bound opening 135. Accordingly, component 310 of the lower lead assembly is above the contacts 210 of the lower contact assembly 240A, whereas component 310 of the upper lead assembly is below the contacts 210 of the upper contact assembly 240B.

FIG. 3 is a perspective view of lower contact assembly 240A without insulative portion 220A. Contact assembly 240A may include shields, here shown as shields 340, 342, 344 and 346. In this example, groups 350A and 350B of contacts 210 on each end of the row 212A are designated for carrying high speed signals, whereas a group 352 of contacts 210 in the central portion of the row 212A is designated for low speed signals. In this example, shields 340 and 344 are connected to first type contacts 320 within group 350A at one end of the row and shields 342 and 346 are connected to first type contacts 320 within group 350B at the other end of the row. In this example, the row 212A of contacts 210, at least in the segments designated for high speed signals, has pairs of second type contacts 330 bounded on each side by a first type contact 320. Each of the shields 340, 342, 344 and 346 is corrugated with peaks and valleys. The valleys may be attached (e.g. by welding) to the first type contacts and the valleys may be over, but separated from, the pair of second type contacts. Though not shown for simplicity, contact assembly 240B may have shields in corresponding locations.

Component 310, which may serve to preload second type contacts 330, is shown engaged to the contacts 210 of contact assembly 240A. In this example, component 310 is attached to first type contacts 320 by welding, for example, and abuts the second type contacts 330. While each of the contacts 210 may have the same general configuration, first type contacts 320 have a longer distal portion 218 than second type contacts 330. The first type contacts 320 may be, for example, ground contacts or low speed signal contacts, while the second type contacts 330 with the shorter distal portion 218 may be high speed signal contacts. The longer distal portion 218 of the ground contacts 320 facilitates preloading and does not negatively affect signal integrity to the same extent that distal portions 218 of the same length would have on high speed signal contacts. In the example illustrated, component 310 is mechanically coupled at a proximal portion 214 of contacts 210.

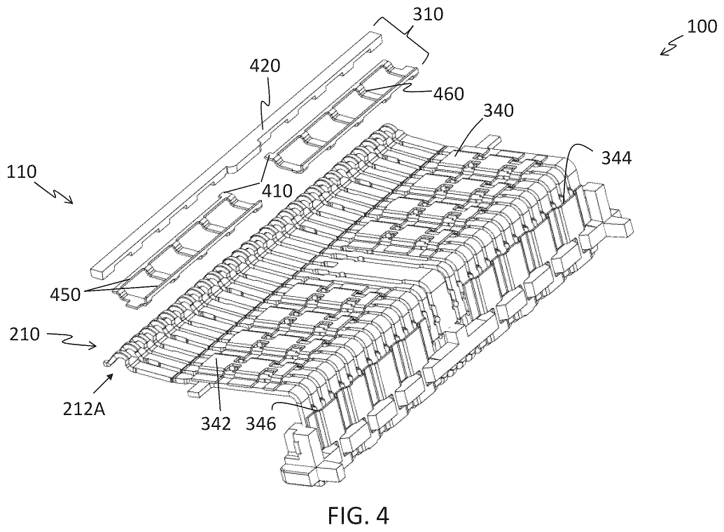

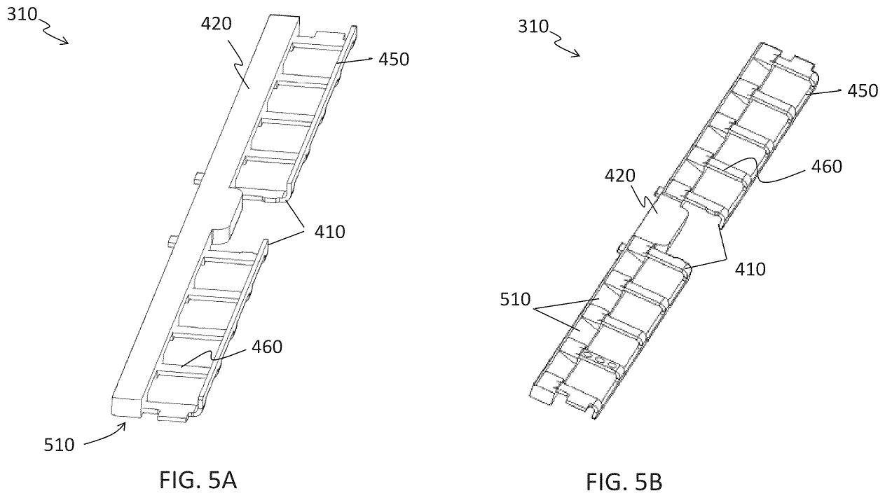

FIG. 4 is a partially exploded view of the lead assembly of FIG. 3, showing that component 310 may include multiple portions. Component 310 in this example includes two conductive portions 410 and an insulative portion 420. In this example, each of the conductive portions 410 aligns with a group 350A or 350B of contacts 210 of the contact assembly 240A with contacts 330 designated for high speed signals. While the exploded view of FIG. 4 shows the conductive portions 410 and insulative portion 420 of the component 310, the component 310 may be secured in the connector 100 as an integral component. The insulative portion 420, for example, may be attached to one or more conductive portions 410. The insulative portion may be overmolded on the conductive portions, for example, such as is illustrated in FIGS. 5A and 5B.

The conductive portion 410 of the component 310 may be electrically and/or mechanically connected to only first type contacts 320. Such a connection may be formed by welding or soldering, for example. In the example illustrated, each conductive portion 410 includes rails 450 extending parallel to the row of contacts 210. The rails 450 are joined by crossbars 460. The crossbars 460 may align with first type contacts 320, which may be ground contacts. In this example, the crossbars 460 include flattened portions, which may be attached to respective ground contacts, such as by welding. In this example, the crossbars 460 are U-shaped with the flattened portions at the bottom of the U and the rails 450 attached to the crossbars 460 at the opposite end of the U such that the rails 450 are offset from the ground contacts as well as the signal contacts in the same row. Such a conductive portion 410 may be formed by stamping and forming a sheet of metal.

As FIG. 4 shows, the insulative portion 420 may be molded over one or more conductive portions 410. In this example, insulative portion 420 is molded over the rail 450 that is closest to the distal end of the contacts 210. The rail 450 may provide mechanical integrity to the insulative portion 420 and/or may interconnect the first type contacts 320 to which the crossbars 460 are attached. In the example shown, the insulative portion 420 spans an entire row 212A (as shown) or 212B of contacts 210. FIGS. 5A and 5B show a component 310 from opposite perspectives. Regardless of whether the insulative portion 420 spans the entire row or a portion, the insulative portion 420 may have segments 510 that align with second type contacts 330, which in this example are signal contacts, and abut those signal contacts. These segments 510 are between the crossbars 460 and may be reinforced by a rail 450 of the conductive portion 410. Segments 510 may have sufficient mechanical integrity to transfer a preload force to the signal contacts.

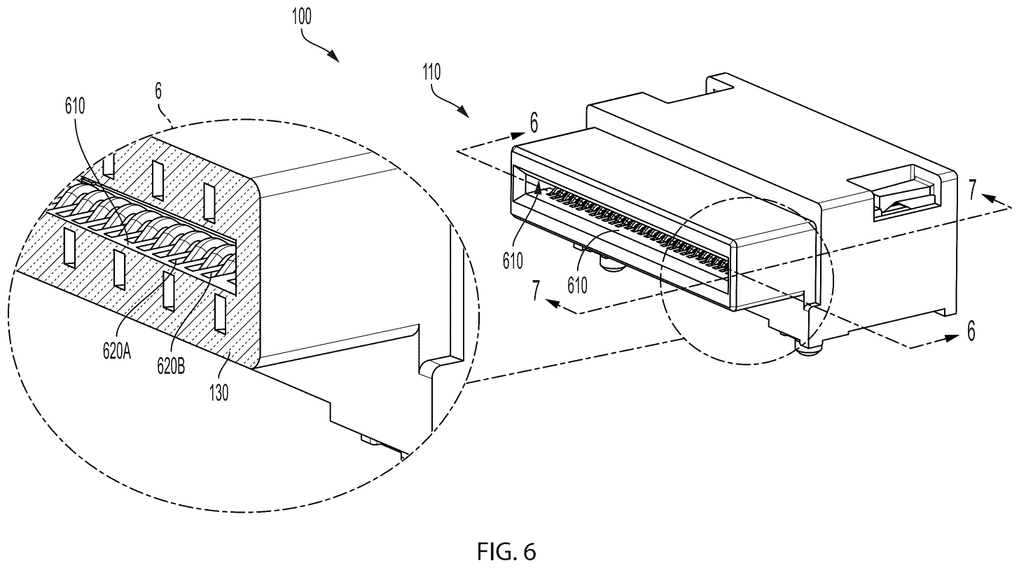

FIG. 6 is a perspective view of a connector 100. Call out 6 shows an enlarged cross-sectional view of a portion of the interface port 110 taken along line 6-6. Housing 130 includes a plurality of channels 620A and 620B. A mating portion of each of the contacts may be, at least in part, positioned in a respective channel, with first type contacts 320 positioned in channels 620A and second type contacts 330 positioned in channels 620B. In this example, channels 620A are longer than channels 620B to accommodate the longer distal portions 218 of the first type contacts 320.

Call out 6 reveals that housing 130 includes features for preloading the first type contacts 320. In this example, those features are provided by preload shelf 610, with segments that align at least with first type contacts 320. A similar cross segment, preload shelf 610, spans the second row 212B of contacts that are not visible in FIG. 6. In this example, preload shelf 610 spans at least the channels 620A that receive the first type contacts 320. In the example illustrated, preload shelf 610 spans the distal portions of the channels 620A. The elongated tips of the first type contacts 320 may engage preload shelf 610, which may hold the first type contacts 320 in the preloaded position.

As shown in the example of FIG. 6, preload shelf 610 may span a row 212A or 212B of contacts 210. In such a configuration, segments of the preload shelf 610 may align with second type contacts 330 in the row. However, as the second type contacts 330 have shorter tips than the first type contacts 320, the second type contacts 330 may not engage the preload shelf 610.

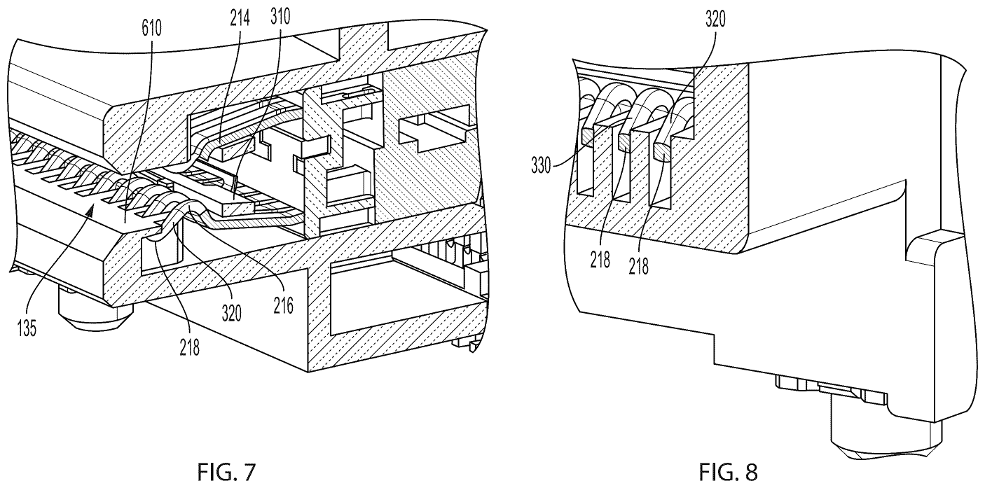

FIG. 7 shows an enlarged cross-sectional view of the interface port 110, taken along the line 7-7 in FIG. 6. The cross-sectional view in FIG. 7 shows the distal portion 218 of a first type contact 320 held under the preload shelf 610. Because of the relatively longer distal portions 218 of the first type contacts 320 (e.g., ground contacts), as compared with the relatively shorter distal portions 218 of the second type contacts (e.g., high speed signal contacts), the distal portions 218 of the first type contacts 320 are held under the preload shelf 610 while the distal portions 218 of the second type contacts 330 do not extend enough to be held under the preload shelf 610. Rather, as described above in connection with FIGS. 3-5B, deflection of the first type contacts 320 into a preloaded state may cause component 310 to press against the second type contacts 330, deflecting them into a preloaded state. Accordingly, the component 310 preloads the second type contacts 330 based on the preloading of the first type contacts 320 and the mechanical coupling of the component 310 to both the first type contacts 320 and the second type contacts 330.

Components 310 are shown attached to the contacts 210 of a row in a location in which they do not interfere with a mating component inserted into opening 135. In the example illustrated in FIG. 7, the proximal portions 214 extend from respective insulative portions 220A and 220B of the contact assemblies and bend towards the centerline of opening 135. Components 310 are attached to a portion of the proximal portions 214 offset from the contact portions. In this configuration, a mating component inserted into opening 135 will first contact the contact portions 216, which will further deflect the beam forming the mating portion of the contact 210, which in turn will move component 310 out of the path of the mating component as it is inserted into opening 135.

FIG. 8 is a cross-sectional view through a plane parallel to the sectional plane illustrated in callout 6. In this example, however, the sectional plane is between the tip of the first type contact and the tip of the second type contact such that the distal portions 218 of the first type contacts 320 are shown in cross section while the tips of the shorter distal portion 218 of the second type contacts 330 are visible. The sectional plane of FIG. 8 is on the proximal side of preload shelf 610, such that preload shelf 610 is not visible in this view.

A connector using techniques as described herein may be assembled according to a method that results in both first type contacts and second type contacts being preloaded without the second type contact beams directly engaging to the connector housing. According to such a method, one or more rows of contacts may be inserted into a connector housing with an opening comprising a mating port, such as opening 135.

One or more rows of contacts may be inserted into the housing with contact portions, such as contact portions 216, extending into the openings. The contacts may be formed to have a rest state in which the tips of the beams would extend into the opening, too. However, the contacts may be preloaded by deflecting the beams from this rest state in a direction towards a surface of the housing bounding the opening. An assembly tool, for example, may be used to deflect the beams as the contacts are inserted into the housing.

The tips may be secured in this position, such as is illustrated in FIG. 1. In FIG. 1 and FIG. 6, for example, the tips of the rows of contacts are not visible because they are behind the front surface of the housing. In this state, the tips will not interfere with a mating component inserted into the opening and the beams will be preloaded.

The contacts may be inserted into the housing in groups, such as one row at a time. In the example of FIG. 2, for example, one contact assembly may be inserted at a time or multiple contact assemblies may be held together, such as is illustrated in FIG. 2, and inserted into the housing together.

For a connector with first type contact beams and second type contact beams, different mechanisms may be used to secure the first and second contact beams in their preloaded states. Distal portions of the first type contact beams may be engaged with the housing such that the first type contact beams are held in a preload state. The second type contact beams may be held in a preload state by a component mechanically coupled to the first type contact beams and the second type contact beams. Component 310, for example, may hold the second type contact beams in a preload state.

In some examples, the first type contacts may have longer distal portions than the second type contacts. These longer distal portions may engage with the housing. The distal portions of the first type contact beams may be engaged to a preload shelf, for example.

In some examples, the housing may have a plurality of channels. Tips of the first type contact beams may be engaged to the housing within channels of the plurality of channels when in the preload state. In contrast, the distal portions of the second type contact beams may not be engaged to the housing when the second type contact beams are held in the preload state. For example, tips of the second type contact beams are cantilevered within channels of the plurality of channels when in the preload state.

Having thus described several aspects of at least one embodiment of this invention, it is to be appreciated that various alterations, modifications, and improvements will readily occur to those skilled in the art.

As an example, component 310 was illustrated as having two parallel rails 450 with an insulative covering on one of the rails. In other examples, there may be insulative coverings on both of the rails or there may be only one rail.

A component, such as component 310 may preload high speed signal contacts and/or low speed signal contacts. In some examples, low speed signal contacts may be preloaded by engaging their distal portions to the housing. In such examples, an insulative preload component may be mechanically connected to the low speed signal contacts and the preload component may then urge high speed signal contacts into a preload state.

As another example, a single component 310 was illustrated per row of signal contacts. In other examples, two or more such components may be attached to each row.

As yet a further example, contacts with surface mount mounting portions were illustrated. In other examples, contacts may have press fit mounting portions or mounting portions of other configurations.

As another example, a connector was depicted as having two rows of contacts. In other examples, a connector may have more than two rows of terminals, such as four rows.

As yet another example, a component to aid in preloading second type contacts was described as a composite structure with conductive and insulative portions integrally formed. In other examples, a component with only an insulative portion may be used instead or in addition to such a composite component.

Further, a paddle card was described as an example of a substrate in a cable connector. Other substrates may be used instead or in addition to a paddle card. A substrate, for example, might be formed of other materials or might be formed in other ways, such as by insert molding conductive elements in a tongue of plastic or other insulative material, to form one or more members that may serve as a substrate.

As another example, first type contacts may differ from the second type contacts in ways other than the length of their distal portions. The first type contacts, for example, may be wider. or in some examples narrower, than the second type contacts. As another example, the proximal portions 214 of the first type contact may be longer, or in some examples shorter, than the proximal portions of the second type contacts.

Such alterations, modifications, and improvements are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In an example, a connector may include a port with an opening. The connector may also include a row of contacts including a plurality of signal contacts and a plurality of ground contacts. Each signal contact of the plurality of signal contacts and each ground contact of the plurality of ground contacts may include a beam including a proximal portion, a distal portion, and a curved contact portion between the proximal portion and the distal portion. The distal portions of plurality of signal contacts may be shorter than the distal portions of the plurality of ground contacts.

Such a connector may optionally include one or more of the following features or characteristics:
the connector includes a component including an insulative portion and a conductive portion. The conductive portion and the insulative portion of the component are attached.
the insulative portion is plastic overmolded on the conductive portion such that the plastic is attached to the conductive portion.
the conductive portion comprises a plurality of rails that extend parallel with the row of contacts and crossbars that connect the rails.
the insulative portion is attached to a rail of the plurality of rails.
the crossbars are connected to respective ground contacts of the plurality of ground contacts.
the conductive portion of the component is a first conductive portion. The component further comprises a second conductive portion. The first conductive portion is attached to ground contacts of the plurality of ground contacts at a first end of the row The second conductive portion is attached to ground contacts of the plurality of ground contacts at a second end of the row, opposite the first end.
the connector also includes a housing with a preload shelf spanning the row of contacts, wherein the distal portions of the plurality of ground contacts engage the preload shelf such that the plurality of ground contacts are in a deflected state, and the plurality of signal contacts are deflected based on mechanical coupling to the component and based on mechanical coupling between the component and the plurality of ground contacts.
the connector also includes a second plurality of signal contacts, wherein the distal portions of second plurality of signal contacts are a same length as the distal portions of the plurality of ground contacts.
the connector also includes a housing with the opening formed therein. The opening includes a side including a plurality of channels therein with cross segments spanning at least a first subset of the plurality of channels. The distal portions of the first type contacts engage the cross segments spanning the channels of the first subset, and the cross segments are disposed beyond distal tips of the second type contacts.

All definitions, as defined and used herein, should be understood to control over dictionary definitions, definitions in documents incorporated by reference, and/or ordinary meanings of the defined terms.

Terms signifying direction, such as “upwards” and “downwards” or front and back were used in connection with some embodiments. These terms were used to signify direction based on the orientation of components illustrated or connection to another component, such as a surface of a printed circuit board to which a termination assembly is mounted or the mating face of a connector. It should be understood that electronic components may be used in any suitable orientation. Accordingly, terms of direction should be understood to be relative, rather than fixed to a coordinate system perceived as unchanging, such as the earth's surface.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A connector comprising:
a port comprising an opening and a plurality of contact beams disposed in a row, wherein the plurality of contact beams comprise a plurality of first type contact beams and a plurality of second type contact beams; and
a component, wherein the component is:
mechanically coupled to the first type contact beams and the second type contact beams;
electrically coupled to the second type contact beams; and
insulated from the second type contact beams.

2. The connector according to claim 1, further comprising a housing comprising a plurality of channels aligned with respective contact beams of the plurality of contact beams.

3. The connector according to claim 2, wherein
the contact beams of the plurality of contact beams each comprises a proximal portion, a curved portion, a tip and a distal portion between the curved portion and the tip;
the distal portions of the plurality of contact beams are disposed in respective channels of the plurality of channels; and
the curved portions of the plurality of contact beams extend into the opening.

4. The connector according to claim 3, wherein the distal portions of the first type contact beams are engaged with the housing such that the first type contact beams are deflected to a preloaded position.

5. The connector according to claim 4, wherein the component urges the second type contact beams into a deflected state such that the second type contact beams are deflected into a preload position based on the first type contact beams being deflected into a preloaded position.

6. The connector according to claim 2, wherein
the plurality of contact beams is a first plurality of contact beams;
the row is a first row; and
the connector further comprises:
a second plurality of contact beams disposed in a second row, the second plurality of contact beams comprising a plurality of first type contact beams and a plurality of second type contact beams;
a second component, wherein the second component is:
mechanically coupled to the first type contact beams and the second type contact beams of the second plurality of contact beams;
electrically coupled to the second type contact beams of the second plurality of contact beams; and
insulated from the second type contact beams of the second plurality of contact beams.

7. The connector according to claim 6, wherein the housing further comprises a second plurality of channels aligned with respective contact beams of the second plurality of contact beams.

8. The connector according to claim 7, wherein:
the contact beams of the second plurality of contact beams each comprises a proximal portion, a curved portion, a tip and a distal portion between the curved portion and the tip;
the distal portions of the second plurality of contact beams are disposed in respective channels of the plurality of channels;
the curved portions of the second plurality of contact beams extend into the opening; and
the distal portions of the first type contact beams of the second plurality of contact beams are engaged with the housing such that the first type contact beams are deflected to a preloaded position.

9. The connector according to claim 8, wherein the second component urges the second type contact beams of the second plurality of contact beams into a deflected state such that the second type contact beams are deflected into a preload position based on the first type contact beams of the second plurality of contact beams being deflected into a preloaded position.

10. The connector according to claim 9, wherein:
the first plurality of contact beams and the second plurality of contact beams comprise mating portions of a plurality of contacts;
the plurality of contacts further comprise mounting portions disposed in a plurality of rows at a mounting face of the connector; and
the mounting face is configured to couple the connector to a printed circuit board (PCB).

11. A connector comprising:
a housing comprising an opening;
a contact assembly disposed within the housing, the contact assembly comprising:
an insulative portion;
a plurality of contacts disposed in a row, each contact of the plurality of contacts comprising a beam comprising a cantilevered portion, the cantilevered portion comprising:
a proximal portion mechanically coupled to and extending from the insulative portion; and
a contact portion connected to the proximal portion and extending into the opening, and
a distal portion extending beyond the contact portion,
wherein:
the plurality of contacts comprises first type contacts and second type contacts; and
the first type contacts have longer distal portions than the second type contacts;
a component comprising an insulative portion, wherein:
the component is attached to the first type contacts; and
the insulative portion of the component abuts the second type contacts.

12. The connector according to claim 11, wherein the component further comprises a conductive portion attached to the first type contacts.

13. The connector according to claim 12, wherein the conductive portion and the insulative portion of the component are attached.

14. The connector according to claim 13, wherein the insulative portion is plastic overmolded on the conductive portion such that the conductive portion and the plastic are attached.

15. The connector according to claim 10, wherein the first type contacts are ground contacts.

16. The connector according to claim 15, wherein the second type contacts are signal contacts.

17. The connector according to claim 16, wherein the second type contacts are disposed within the row in pairs, with each pair bounded on two sides by a ground contact.

18. The connector according to claim 11, wherein:
the opening has a first side and a second side opposite the first side;
the contact assembly is a first contact assembly;
the component is a first component;
the plurality of contacts are a first plurality of contacts;
the row is a first row and the first plurality of contacts in the first row are arranged at the first side of the opening with the first plurality of contacts between the first component and the first side of the housing;
and the connector further comprises:
a second plurality of contacts, including the first type contacts and the second type contacts, disposed in a second row, parallel to the first row, arranged at a second side of the opening, and
a second component comprising an insulative portion, wherein the second component is attached to the first type contacts of the second plurality of contacts; and
the insulative portion of the second component abuts the second type contacts of the second plurality of contacts.

19. The connector according to claim 18, wherein the housing comprises:
a first preload shelf at the first side of the opening; and
a second preload shelf at the second row at the second side of the opening.

20. The connector according to claim 19, wherein:
the distal portions of the first type contacts of the plurality of contacts of the first row engage the first preload shelf in a deflected state such that the first type contacts in the first row are in a preloaded condition, and
the distal portions of the first type contacts of the plurality of contacts of the second row engage the second preload shelf in a deflected state such that the first type contacts in the second row are in a preloaded condition.

21. The connector according to claim 20, wherein:
the second type contacts in the first row are deflected in a first direction away from a centerline of the opening based on mechanical coupling to the insulative portion of the first component and on mechanical coupling of the first component to the first type contacts in the first row, and
the second type contacts in the second row are deflected away from the centerline of the opening in a second direction, opposite the first direction, based on mechanical coupling to the insulative portion of the second component and on mechanical coupling of the second component to the first type contacts in the second row.

22. A method of assembling a connector comprising a housing comprising an opening comprising a mating port, and a row comprising a plurality of contact beams comprising first type contact beams and second type contact beams wherein each of the plurality of contact beams comprises a proximal portion, a distal portion, and a curved portion between the proximal portion and the distal portion, the method comprising:
deflecting the plurality of contact beams from a rest state and positioning the plurality of beams within the housing such that the curved portions of the plurality of contact beams extend into the opening; and
engaging the distal portions of the first type contact beams with the housing such that the first type contact beams are held in a preload state and the second type contact beams are held in a preload state by a component mechanically coupled to the first type contact beams and the second type contact beams.

23. The method according to claim 22, wherein:
the first type contact beams have longer distal portions than the second type contact beams; and
the distal portions of the second type contact beams are not engaged to the housing when the second type contact beams are held in the preload state.

24. The method according to claim 22, wherein:
engaging the distal portions of the first type contact beams with the housing comprises engaging tips of the first type contact beams to a preload shelf.

25. The method according to claim 22, wherein:
the housing comprises a plurality of channels;
engaging the distal portions of the first type contact beams with the housing comprises engaging tips of the first type contact beams to the housing within channels of the plurality of channels; and
tips of the second type contact beams are not engage to the housing within channels of the plurality of channels when in the preload state.
